(19) United States
(12) Patent Application Publication
(10) Pub. No.: US 2025/0271535 A1
(43) Pub. Date: Aug. 28, 2025

(54) WIRELESS COMMUNICATION DEVICE AND BOARD

(71) Applicant: DENSO CORPORATION, Kariya-city (JP)

(72) Inventors: Tatsuya INAGAKI, Kariya-city (JP); Yuuji Kakuya, Kariya-city (JP)

(21) Appl. No.: 19/199,089

(22) Filed: May 5, 2025

Related U.S. Application Data
(63) Continuation of application No. PCT/JP2023/033894, filed on Sep. 19, 2023.

(30) Foreign Application Priority Data
Nov. 11, 2022 (JP) 2022-181252

(51) Int. Cl. G01S 5/02

(52) U.S. Cl. CPC G01S 5/0263; G01S 5/0284

(57) ABSTRACT

A wireless communication device or a board for a vehicle and used for wirelessly communicating with a mobile device includes: a plurality of antennas; and a control module configured to control an operation of the plurality of antennas. The plurality of antennas include: a first antenna; and a second antenna. The control module is configured to: acquire a first antenna strength that is a reception strength, at the mobile device, of a wireless signal transmitted from the first antenna; perform distance measurement communication; transmit data indicating a distance to a position determination device mounted on the vehicle.

### CROSS REFERENCE TO RELATED APPLICATIONS

The present application is a continuation application of International Patent Application No. PCT/JP2023/033894 filed on Sep. 19, 2023, which designated the U.S. and claims the benefit of priority from Japanese Patent Application No. 2022-181252 filed on Nov. 11, 2022. The entire disclosures of all of the above applications are incorporated herein by reference.

### TECHNICAL FIELD

The present disclosure relates to a wireless communication device and a board that are connected to an electronic control unit via a cable.

### BACKGROUND

As a comparative example, a mobile device observes a reception strength of signals transmitted from an exterior antenna and an interior antenna, and an electronic control unit determines a position of the mobile device using the reception strength information observed by the mobile device. The exterior antenna is an antenna mounted on the external surface of the vehicle, such as an exterior door handle. The in-vehicle antenna is an antenna placed inside the vehicle. A communication module that includes an antenna may be referred to as a wireless communication device. Generally, wireless communication devices placed at various positions in a vehicle are often connected to an electronic control unit via communication cables.

However, depending on the configuration of the wireless communication device, the current involved in wireless transmission from the wireless communication device may flow into the communication cable as a leakage current, which may radiate noise into the vehicle interior. As a technology for preventing such leakage current, in the configuration of the comparative example, a stripline serving as a leakage current blocking unit having a length of approximately one-quarter of the wavelength (hereinafter also referred to as λ) of target radio waves is formed so as to branch off from the feed line. The target radio waves refer to radio waves that are the target of transmission and reception, in other words, radio waves in the frequency band used for communication with mobile devices.

### SUMMARY

According to an aspect of the present disclosure, a wireless communication device or a board for a vehicle and used for wirelessly communicating with a mobile device includes: a plurality of antennas; and a control module configured to control an operation of the plurality of antennas. The plurality of antennas include: a first antenna; and a second antenna. The control module is configured to: acquire a first antenna strength that is a reception strength, at the mobile device, of a wireless signal transmitted from the first antenna; perform distance measurement communication; transmit data indicating a distance to a position determination device mounted on the vehicle.

### BRIEF DESCRIPTION OF THE DRAWINGS

FIG. 1 is a diagram showing an overall view of a vehicle electronic key system.

FIG. 2 is a functional block diagram of a smart ECU.

FIG. 3 is a functional block diagram of a wireless device.

FIG. 4 is a diagram showing an example of arrangement of a first antenna and a second antenna on a board.

FIG. 5 is a flowchart showing an example of a strength measurement process.

FIG. 6 is a flowchart showing an example of a distance measurement process.

FIG. 7 is a diagram showing an example of a flow of communication between a communication device and a mobile device for strength measurement and distance measurement.

FIG. 8 is a flowchart showing an example of a position determination process executed by the smart ECU.

FIG. 9 is a diagram for describing an overview of an active two-way system.

FIG. 10 is a diagram for describing an overview of a passive two-way system.

FIG. 11 is a diagram for describing an overview of a one-way system.

FIG. 12 is a diagram showing a modification of an antenna shape.

FIG. 13 is a diagram showing a configuration including multiple first antennas.

FIG. 14 is a flowchart for describing an example of a strength measurement process when the multiple first antennas are present.

FIG. 15 is a diagram showing a configuration including multiple second antennas.

FIG. 16 is a diagram for describing another example of a calculation method of a second phase difference.

### DETAILED DESCRIPTION

As a first configuration for determining the position of a mobile device relative to a vehicle, the inventers of the present disclosure have considered a configuration for determining whether a mobile device is present inside a vehicle based on an indoor device strength and an outdoor device strength. The indoor device strength here refers to a reception strength, at the mobile device, of a signal transmitted from the indoor device, which is a wireless communication device placed in a vehicle interior. The outdoor device strength refers to the reception strength, at the mobile device, of a signal transmitted from an outdoor device, which is a wireless communication device mounted on the external surface of the vehicle. In either case, the mobile device is an entity that observes the reception strength, and the observed reception strength information can be transmitted back from the mobile device to the wireless communication device.

However, since it is difficult to achieve the desired level of position determination accuracy with the above first configuration, the inventers considered, as a second configuration, a system that determines the position of the mobile device using distance information to the mobile device determined based on a distance-related value in addition to the reception strength. As a result, the following findings (1) to (3) were obtained.

The distance-related value here refers to a parameter other than reception strength that takes a value according to the device distance, such as a round trip time or a transmission reception phase difference for each frequency. The transmission reception phase difference is a phase difference between the transmission signal and the reception signal. The distance-related value is calculated by causing the wireless communication device to perform a predetermined communication for distance measurement with the mobile device. The communication for distance measurement is communication for measuring the distance-related value, and may include a process of transmitting and receiving signals between the wireless communication device and the mobile device.
(1) When a wireless communication device includes multiple antennas, it is possible to improve the accuracy of measuring the distance to a mobile device by averaging the distance measurement results from each antenna.
(2) When the antenna provided on the board is a λ/4 antenna, the board size can be reduced, but leakage current into the communication cable may increase. In this case, the λ/4 antenna refers to an antenna having an electrical length of λ/4, such as an L-shaped antenna or an inverted F antenna.
(3) When the leakage current from the outdoor device to the communication cable is large, inversion phenomenon in the reception strength may occur when the mobile device receives a noise signal radiated from the communication cable connected to the outdoor device. This is because the communication cable connected to the outdoor device passes through the inside of the vehicle.

The inversion phenomenon of reception strength here refers to a situation in which the outdoor device strength becomes higher than the indoor device strength when the mobile device is inside the vehicle, i.e., a situation in which the indoor device strength should actually be higher than the outdoor device strength. One solution method to solve the difficulty of the above (3) is to provide a stripline/stub having a length of λ/4 as a leakage current blocking unit near the feed point of each antenna, following the configuration of the comparative example. However, this assumed configuration may result in an increase in the board area and an increase in costs.

Incidentally, since the propagation path of a wireless signal is reversible, the inversion phenomenon of the reception strength can occur even when the reception strength is observed not by the mobile device but by a wireless communication device mounted on a vehicle. For example, a signal transmitted from the mobile device inside the vehicle may be received by the communication cable connected to the outdoor device. Thereby, the outdoor device strength is caused to be higher than the indoor device strength.

The present disclosure has been made based on the above considerations or points of view, and it is an object to reduce the size of a board in a wireless communication device including multiple antennas for communicating with a mobile device while reducing an occurrence of a reception strength inversion phenomenon.

A first wireless communication device disclosed herein is a wireless communication device mounted on an external surface of a vehicle and used for wirelessly communicating with a mobile device, and the wireless communication device includes: multiple antennas; and a control module configured to control an operation of the multiple antennas. The multiple antennas include: a first antenna that is a half-wave antenna; and a second antenna that is not a half-wave antenna. The control module is configured to: acquire a first antenna strength that is a reception strength, at the mobile device, of a wireless signal transmitted from the first antenna; perform distance measurement communication using the first antenna, the distance measurement communication being communication for measuring a distance-related value that is a parameter different from the reception strength and that takes a value according to a distance to the mobile device; perform the distance measurement communication using the second antenna; calculate a distance to the mobile device based on a first distance-related value obtained in the distance measurement communication using the first antenna and a second distance-related value obtained in the distance measurement communication using the second antenna; and transmit data indicating the distance to the mobile device to a position determination device mounted on the vehicle in association with data indicating the first antenna strength.

According to the above configuration, the half-wave antenna is used as the first antenna to measure the reception strength. The half-wave antenna is less likely to generate a current in the ground plane than a λ/4 antenna, so that it is possible to reduce leakage current into a communication cable. Accordingly, it is possible to reduce the possibility of inversion phenomenon of the reception strength caused by noise resulting from leakage current into the communication cable.

In addition, of the multiple antennas, the second antenna that is not used for measuring the reception strength does not need to be a half-wave antenna, but may be a λ/4 antenna. Furthermore, since the second antenna does not transmit a signal for measuring the strength, there is no need to add a stripline having a length of λ/4 to the second antenna as a leakage current blocking unit. Therefore, in a wireless communication device having multiple antennas for directly communicating with a mobile device, it is possible to achieve both size reduction of the board and prevention of the occurrence of the reception strength inversion phenomenon. Additionally, distance-related values are measured for each antenna. Therefore, it is also possible to improve the accuracy of measuring the distance to the mobile device.

A second wireless communication device disclosed herein is a wireless communication device mounted on a vehicle and used for wirelessly communicating with a mobile device, and the wireless communication device includes: multiple antennas; and a control module configured to control an operation of the multiple antennas. The multiple antennas include: a first antenna that is a half-wave antenna; and a second antenna that is not a half-wave antenna. The control module is configured to: acquire a first antenna strength that is a reception strength, at the mobile device, of a wireless signal transmitted from the first antenna; perform distance measurement communication for the mobile device to calculate a device distance that is a distance from the mobile device to the wireless communication device for each antenna; receive, from the mobile device, data indicating the device distance; and transmit a signal indicating the reception strength and the distance to a position determination device.

The difference between the above second wireless communication device and the above first wireless communication device is that the mobile device has a function of calculating the distance from the wireless communication device to the mobile device. The configuration of the above second wireless communication device also provides the same effects as the first wireless communication device.

A third wireless communication device disclosed herein is a wireless communication device mounted on an external surface of a vehicle and used for wirelessly communicating with a mobile device, and the wireless communication device includes: multiple antennas; and a control module configured to control an operation of the multiple antennas. The multiple antennas include: a first antenna that is a half-wave antenna; and a second antenna that is not a half-wave antenna. The control module is configured to: acquire a first antenna strength that is a reception strength of a wireless signal received by the first antenna from the mobile device; perform distance measurement communication using the first antenna, the distance measurement communication being communication for measuring a distance-related value that is a parameter different from the reception strength and that takes a value according to a distance to the mobile device; perform the distance measurement communication using the second antenna; calculate a distance to the mobile device based on a first distance-related value obtained in the distance measurement communication using the first antenna and a second distance-related value obtained in the distance measurement communication using the second antenna; and transmit data indicating the distance to the mobile device to a position determination device mounted on the vehicle in association with data indicating the first antenna strength.

The difference between the third wireless communication device and the first wireless communication device is that the wireless communication device observes the reception strength. Since the transmission and reception of wireless signals are reversible, the configuration of the third wireless communication device achieves the same effects as the first wireless communication device.

Further, a board of then present disclosure is a board for a wireless communication device mounted on an outer door handle of a vehicle, and includes: a ground layer; a first antenna that is a half-wave antenna for performing wireless communication with a mobile device; a second antenna that is an antenna for performing wireless communication with a mobile device of a type different from the first antenna, and is an ungrounded antenna that does not have a portion electrically connected to the ground layer; and a control module configured to control an operation of the multiple antennas. The control module includes: a strength acquisition unit configured to acquire a first antenna strength that is a reception strength, at the mobile device, of a wireless signal transmitted from the first antenna; a distance acquisition unit configured to acquire data indicating a distance from the mobile device to the wireless communication device by sequentially causing the plurality of antennas to communicate with the mobile device; and a report processing unit configured to transmit data indicating the distance to the mobile device to a position determination device mounted on the vehicle in association with data indicating the first antenna strength.

The above-mentioned board is a board on which various components constituting the first wireless communication device are mounted, and provides the same effects as the first wireless communication device.

Furthermore, the present disclosure regards the leakage current blocking unit as an optional element, and does not prohibit the introduction of the leakage current blocking unit.

Hereinafter, an embodiment of a vehicle electronic key system to which a wireless communication device according to the present disclosure is applied will be described with reference to the drawings. The present disclosure is not limited to the following embodiment, and various modifications described below are also included in the technical scope of the present disclosure. Furthermore, in addition to the following, various changes can be made within the range that does not deviate from the scope of the present disclosure. The various supplements and modifications described below may be implemented in any suitable combination as long as no technical contradiction occurs. For components having the same function, the same reference numerals are used, and their descriptions may be omitted. Furthermore, when only a part of a configuration is mentioned, the descriptions given elsewhere may apply to other parts.

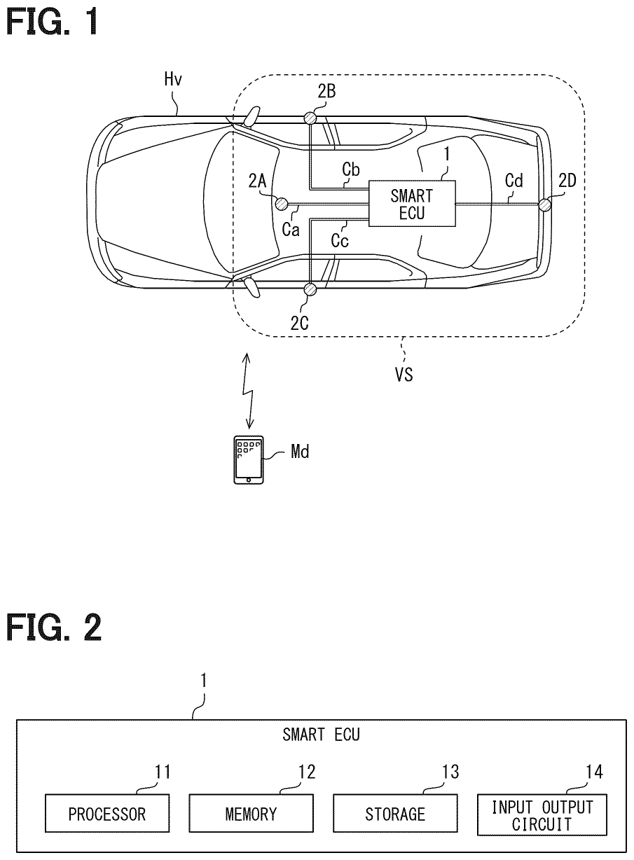

As shown in FIG. 1, the electronic key system for a vehicle according to the present embodiment includes an in-vehicle system VS and a mobile device Md. The in-vehicle system VS includes a smart ECU 1 and multiple wireless devices 2. The ECU is an abbreviation of Electronic Control Unit.

The wireless device 2 is a communication module for performing two-way wireless communication using radio waves in a predetermined frequency band with a mobile device Md, which is a device carried by a user of a vehicle Hv. Each wireless device 2 complies with the same communication standard. Here, as an example, each wireless device 2 is configured to perform wireless communication with the mobile device Md in accordance with Bluetooth (registered trademark) Low Energy (hereinafter, BLE communication). That is, the wireless device 2 and the mobile device Md are configured to transmit and receive radio waves in the 2.4 GHz band. Hereinafter, the term of BLE may be replaced with Bluetooth LE or SRWC (short range wireless communication).

In the following, a case will be described in which the in-vehicle system VS is set to act as a master/scanner in data communication with the mobile device Md, and the mobile device Md is set to serve as a slave/advertiser. That is, by receiving an advertising signal from the mobile device Md, the in-vehicle system VS establishes a communication connection with the mobile device Md and detects the presence of the mobile device Md (and thus the user) in the periphery of the vehicle Hv. The advertisement signal is a BLE signal for notifying (that is, advertising) the presence of the mobile device Md to another device. The BLE signal is a wireless signal that complies with BLE. The BLE signal may include a code indicating the source or destination. The source and destination can be expressed by a device ID or the like. In addition, the descriptions of wireless signals, BLE signals, data, messages, packets, frames, packages, data sets, information, and the like in the present disclosure may be interpreted interchangeably. Alternatively, the mobile device Md may be set to operate as a master in the communication with the in-vehicle system VS.

The in-vehicle system VS includes, as the wireless device 2, wireless devices 2A to 2D. The wireless device 2A is placed inside the vehicle interior. The wireless device 2A may be placed at any desired position, such as on an instrument panel, the upper end of the windshield, or the center of the ceiling inside the vehicle. The wireless device 2A may be housed inside the housing of the smart ECU 1. The wireless device 2A corresponds to an indoor device. The wireless devices 2B to 2D are wireless devices 2 placed on the external surface of the vehicle Hv. The wireless device 2B is built into an outside door handle for a right front seat. The right front seat is a front seat placed to the right of a center console. When the steering wheel is placed on the right portion of the instrument panel, the right front seat corresponds to the driver seat. The wireless device 2B may be placed on a right B-pillar, a right side mirror, or a right side sill. The wireless device 2B can be referred to as a right outdoor device.

The wireless device 2C is built into the outside door handle for a left front seat. The wireless device 2C may be placed on a left B-pillar, a left side mirror, or a left side sill. The wireless device 2C can be referred to as a left outdoor device. The wireless device 2D is placed near a rear bumper or trunk door. The wireless device 2D can be referred to as a rear outdoor device. The wireless devices 2B to 2D correspond to outdoor devices.

The smart ECU 1 is connected to each of the multiple wireless devices 2 via communication cables C. A communication cable Ca shown in FIG. 1 is a communication cable that connects the smart ECU 1 and the wireless device 2A. A communication cable Cb is a communication cable that connects the smart ECU 1 and the wireless device 2B. A communication cable Cc is a communication cable that connects the smart ECU 1 and the wireless device 2C. A communication cable Cd is a communication cable that connects the smart ECU 1 and the wireless device 2D. Each communication cable C is routed under a seat and the like or inside a plastic door panel. In other words, various communication cables C connected to the wireless devices 2B to 2D serving as outdoor devices are routed inside the vehicle. In addition, the communication cables C may include a configuration as a power cable for supplying power from the vehicle Hv/smart ECU 1 to the wireless device 2. The multiple communication cables C may be bundled together as a harness.

### About Mobile Device

The mobile device Md is a portable and general-purpose information processing terminal having a BLE communication function. The mobile device Md may be any of a variety of communication terminals, such as a smartphone or a wearable device. A wearable device is a device that is worn on the user body when in use. The wearable device may be in various forms, such as a wristband type, a watch type, a ring type, glasses type, or an earphone type. The mobile device Md can also be called a user device or a key device.

The mobile device Md includes a display, a BLE communication module, and a device control unit. The display may be a liquid crystal display or an organic electroluminescent (EL) display. The display displays an image corresponding to an input signal from the device control unit.

The BLE communication module is a communication module for performing BLE communication. The BLE communication module includes a reception strength detection unit that is a functional unit that measures the reception strength of a reception signal. The measured value of the reception signal strength itself may be called a reception signal strength indicator/indication (RSSI). In addition to the received data, the BLE communications module transmits data indicating the measured reception strength together with transmission source information to the device control unit.

In addition, the BLE communication module is configured to transmit and receive a continuous wave (CW) signal of a predetermined waveform as a signal for distance measurement, in addition to a modulated signal for data communication. The CW signal may be a sine wave or a triangular wave. The signal for distance measurement is a signal for measuring the distance from the mobile device Md to the wireless device 2.

In addition, the BLE communication module includes, as a functional unit for distance measurement, a reception phase detection unit that detects the reception phase, which is the phase angle of the reception signal relative to the output signal of the local oscillator, when a CW signal is received. The reception phase corresponds to the output value of the arctangent whose input value is the ratio of a Q (Quadrature-Phase) component to an I (In-Phase) component of the reception signal. The magnitude of the I component corresponds to the strength of the in-phase component of the reception signal. The magnitude of the Q component corresponds to the strength of the perpendicular component of the reception signal. The I component is obtained by multiplying the reception signal by a carrier wave output by a local oscillator. Moreover, the Q component is obtained by multiplying the reception signal by a phase-shifted signal that is obtained by shifting the phase of the output signal of the local oscillator by 90°. The phase-shifted signal can be obtained by passing the output signal of the local oscillator through a phase-shift circuit that shifts the phase by 90°. The local oscillator is a circuit that generates a sine wave or cosine wave of a carrier frequency. The local oscillator is implemented by using a voltage-controlled oscillator (VCO) or the like. The reception phase may be determined based on an IQ signal down-converted to baseband. The detected reception phase information is used for a distance measurement process as described later.

The device control unit executes various arithmetic processes. The device control unit may include a computer equipped with a processor, a random access memory (RAM), storage, and the like. The storage stores the device ID. The storage may also store a key code used in wireless authentication processing with the smart ECU 1. The key code may also be called an encryption key.

The device control unit causes the BLE communication module to transmit an advertisement signal at a predetermined transmission interval. The BLE communication module executes a communication connection process with the in-vehicle system VS based on reception of a connection request from the in-vehicle system VS. The mobile device Md may execute an authentication process (hereinafter, wireless authentication process) via wireless communication based on the establishment of a communication connection with the in-vehicle system VS. The wireless authentication process can be executed by any method, such as a challenge-response method.

When the device control unit of the present embodiment receives a BLE signal transmitted from the vehicle Hv, it returns a response signal in response to the reception signal. When the mobile device Md receives a BLE signal transmitted from the in-vehicle system VS (actually, the wireless device 2), the mobile device Md acquires the reception strength of the reception signal from the BLE communication module. Then, it returns a message including data indicating the reception signal strength. In the present disclosure, the reception strength of a signal transmitted from the wireless device 2 and detected by the mobile device Md is also referred to as device strength. A message including device strength may also be referred to as a device strength message.

The mobile device Md executes a communication sequence for distance measurement based on a request from the in-vehicle system VS. Based on a request from the in-vehicle system VS, the mobile device Md causes the BLE communication module to transmit a CW signal on a specified channel. Interaction between the mobile device Md and the in-vehicle system VS (actually the wireless device 2) will be described separately later.

The mobile device Md may be a smart key that is a dedicated device serving as an electronic key of the vehicle Hv. The smart key is a device that is transferred to the owner together with the vehicle Hv when the vehicle Hv is purchased. The smart key can be regarded as one of accessories of the vehicle Hv. The smart key may have various shapes such as a flat rectangular parallelepiped shape, a flat elliptical shape (so-called fob type), and a card shape. The smart key may be referred to as a vehicle mobile device, a key fob, a key card, an access key, or the like.

### About Smart ECU

The smart ECU 1 is an ECU that determines the device position in cooperation with the wireless device 2. In the present disclosure, the device position refers to the relative position of the mobile device Md with respect to the vehicle Hv. The smart ECU 1 determines whether the mobile device Md is present inside the vehicle based on the communication status between multiple wireless devices 2 and the mobile device Md. The smart ECU 1 corresponds to a position determination device. Since the mobile device Md corresponds to the user, determining the device position corresponds to determining the position of the user. Based on reception of a BLE signal transmitted from the mobile device Md by at least one wireless device 2, the smart ECU 1 can detect that the mobile device Md is present within a specified range outside the vehicle and start a process of determining the device position.

The smart ECU 1 is implemented by use of a computer. That is, as shown in FIG. 2, the smart ECU 1 includes a processor 11, a memory 12, a storage 13, an input output circuit (hereinafter, I/O) 14, and a bus line connecting these components. The processor 11 may be any calculation core such as a CPU (Central Processing Unit). The processor 11 executes various processes for implementing a function of each of functional units described later by accessing the memory 12. The memory 12 is a volatile storage medium such as a RAM.

The storage 13 includes a non-volatile storage medium such as a flash memory. The storage 13 stores a control program executed by the processor 11. Executing the control program by the processor 11 corresponds to executing a vehicle control method corresponding to the control program. Furthermore, the storage 13 has registered therein the device ID of the mobile device Md. Additionally, the storage 13 stores data indicating the mounting position of each wireless device 2 in the vehicle Hv. The I/O 14 is a circuit module for communicating with another device. The smart ECU 1 will be described in detail later.

The smart ECU 1 may be placed in the instrument panel. The smart ECU 1 may be mounted at an overhead console, a right or left C-pillar, under the driver's seat, or the like. The C pillar refers to the third pillar from the front among pillars of the vehicle Hv.

A variety of in-vehicle devices can be directly or indirectly connected to the smart ECU 1. The smart ECU 1 is connected to a door sensor, a start switch, a body ECU, a power supply ECU, and the like via an in-vehicle network so as to be able to communicate with each other.

The door sensor is a sensor for detecting a user operation for unlocking and locking the doors of the vehicle Hv. The door sensor may be a touch sensor or a push switch. The start switch is a push switch for the user to switch on/off the traveling power source. The start switch may also be called a power switch. The body ECU is an ECU that controls the door lock motor and the vehicle lighting equipment. The power source ECU is an ECU that controls the on-off state of the traveling power supply mounted on the vehicle Hv. The traveling power source is a power source for traveling of the vehicle Hv. When the vehicle Hv is an engine vehicle, the ignition power source corresponds to the traveling power source. When the vehicle Hv is an electric vehicle, the traveling power source is a system main relay.

The smart ECU 1 detects unlocking and locking operations based on various data/signals input from sensors, ECUs, switches, and the like mounted on the vehicle Hv. The unlocking operation is a user operation for unlocking the vehicle Hv. The locking operation is an operation for locking the vehicle Hv. The smart ECU 1 can detect a touch operation on the door sensor as an unlocking operation/locking operation.

The smart ECU 1 controls the operations of the wireless devices 2A to 2D. The smart ECU 1 also uses the wireless devices 2A to 2D depending on the purpose. The smart ECU 1 uses the wireless device 2A for both data communication with the mobile device Md and distance measurement. On the other hand, the other wireless devices 2 are used as anchors. The anchor is a wireless device 2 that is used only for determining the position of a mobile device Md. In other words, the anchor refers to the wireless device 2 that is not used for data communication. Here, the data communication refers to communication for transmitting and receiving various data and files, such as data for authentication, data for distance measurement settings, and audio data.

In the present disclosure, a communication device used for data communication is referred to as a gateway communication device. In the present embodiment, the wireless device 2A corresponds to a gateway communication device. The gateway communication device may be a communication device that is in a standby state constantly or intermittently while the vehicle Hv is parked. The gateway communication device may in one aspect be understood as a wireless device 2 that is representative of multiple wireless devices 2. In another aspect, the gateway communication device can also be understood as a wireless device 2 that starts up before the anchor. Such a gateway communicator may be wake-up more frequently/longer than the anchor.

Settings of the gateway communication device may be dynamically changed by the smart ECU 1. When the smart ECU 1 detects a malfunction in the wireless device 2A, the smart ECU 1 may cause the wireless device 2B to function as a gateway communication device. The gateway communication device can also be referred to as a representative device, a central device, a data communication device, or the like.

The smart ECU 1 sets the wireless device 2A, which serves as a gateway communication device, to a scan mode while the traveling power source is off. The scan mode is a state in which advertisements can be received. The scan mode may be a mode in which the standby state is intermittently entered at a predetermined scan interval. The wireless device 2A searches for the mobile device Md by a passive scanning or active scanning method.

The smart ECU 1 can reduce power consumption during parking by turning off the power supplies of the anchor wireless devices 2B to 2D while the traveling power supply is turned off. Of course, the smart ECU 1 may keep the wireless devices 2B to 2D in the scan mode in the same manner as the wireless device 2A. In addition, the smart ECU 1 may respond to a user operation (for example, an unlocking operation) on the vehicle Hv and cause the wireless device 2 to search for the mobile device Md in accordance with the content of the operation.

The smart ECU 1 activates the other wireless devices 2B to 2D based on the communication connection between the wireless device 2A and the mobile device Md. Then, the smart ECU 1 causes each of the wireless devices 2A to 2D to execute the distance measurement process and strength measurement process in a predetermined order. The distance measurement process and the strength measurement process will be described separately later.

The smart ECU 1 acquires communication status data from each wireless device 2 that is generated as a result of the distance measurement process and the strength measurement process. The acquired communication status data is stored in the memory 12 together with information indicating the source of the data (for example, the wireless device number). The communication status data includes distance information and reception strength. The smart ECU 1 determines the device position by combining distance information and reception strength provided by multiple wireless devices 2. An example of the operation of the processor 11 in determining the device position will be described later. The functional block related to the position determination may also be called a position determination unit.

In addition, the smart ECU 1 may respond to a user operation on the vehicle Hv and cooperate with other ECUs to execute control/processing according to the device position. When the smart ECU 1 determines that the mobile device Md is present near a door outside the vehicle and detects that the door sensor has been touched by a user, the smart ECU 1 may execute a process to lock or unlock the door. The functional block that executes the control related to the locking and unlocking of the doors can be called a vehicle control unit. The vehicle control unit may be provided in the smart ECU 1, or may be provided in another ECU called a zone ECU, domain ECU, body ECU, or the like.

### About Communication Device

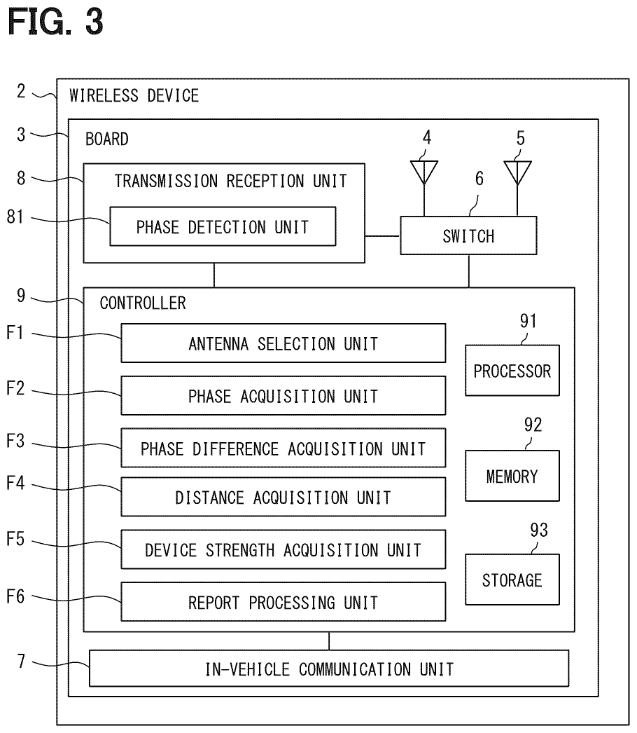

The wireless device 2 is a communication module for performing wireless communication with the mobile device Md according to the BLE standard. The wireless devices 2 have roughly the same configuration. As shown in FIG. 3, each wireless device 2 includes a board 3, a first antenna 4, a second antenna 5, a transmission reception unit 8, a controller 9, a vehicle interior communication unit 7, and a switch 6.

The board 3 is a rectangular printed circuit board. The board 3 has a size suitable for the mounting position. The board 3 is provided with electronic components, analog elements, signal lines, and the like that constitute the wireless device 2. The board 3 is provided with the first antenna 4, the second antenna 5, the switch 6, the vehicle interior communication unit 7, the transmission reception unit 8, the controller 9, and the like. In the present disclosure, the two surfaces of the board 3 are referred to as a first surface and a second surface, respectively. As separately described later, the first surface is a surface on which the first antenna 4 and the second antenna 5 are formed. The first surface may also be referred to as an antenna formation surface. The second surface is the surface opposite to the first surface. The second surface may also be referred to as a back surface.

In addition, in the present disclosure, the four edges of the board 3 are referred to clockwise as a first edge E31, a second edge E32, a third edge E33, and a fourth edge E34. The first edge E31 is an edge extending in the longitudinal direction of the board 3. The second edge E32 is an edge extending in the short direction of the board 3. The second edge E32 is one of the four edges of the board 3 that is perpendicular to the first edge E31. The third edge E33 is the edge opposite to the first edge E31. The fourth edge E34 is the edge opposite to the second edge E32. In another aspect, an edge portion extending in the short direction of the board 3 may be set as the first edge E31. In that case, the second edge E32 can be an edge extending in the longitudinal direction of the board 3.

The board 3 has a ground layer 31 inside or on its back surface. The ground layer 31 is a conductor layer that provides a ground potential (so-called ground). The conductor layer can also be called a conductor plate. Here, the plate shape includes a thin film shape. The ground layer/conductor layer can be read as the ground plate/conductor plate, respectively. The ground layer 31 is electrically connected to a ground line of a communication cable or a power cable connecting the smart ECU 1 and the wireless device 2. Moreover, the ground layer 31 is electrically connected to the ground terminals of various electronic components. In addition to the above configuration, the board 3 may be provided with a power supply circuit that converts the voltage supplied from the vehicle Hv into a voltage suitable for the operation of the controller 9 and the like.

Both the first antenna 4 and the second antenna 5 are antenna elements for transmitting and receiving radio waves in the frequency band used for BLE communication, that is, the 2.4 GHz band. The 2.4 GHz band can be understood as a frequency band that includes multiple channels (Ch 0 to 39) used for BLE communication. In the present disclosure, when there is no need to distinguish between the first antenna 4 and the second antenna 5, such as when describing parts common to the first antenna 4 and the second antenna 5, these may be simply referred to as antennas.

The first antenna 4 and the second antenna 5 are each electrically connected to the transmission reception unit 8 via the switch 6. The switch 6 is a circuit/component for switching the antenna used by the controller 9 for communication with the mobile device Md. The switch 6 has multiple connection states. The switch 6 has a first connection state and a second connection state as connection states. The first connection state is a state in which the first antenna 4 is connected to the transmission reception unit 8. The second connection state is a state in which the second antenna 5 is connected to the transmission reception unit 8. The connection state of the switch 6 is changed by the controller 9. Hereinafter, of the first antenna 4 and the second antenna 5, the antenna connected to the transmission reception unit 8 will also be referred to as a use antenna or effective antenna.

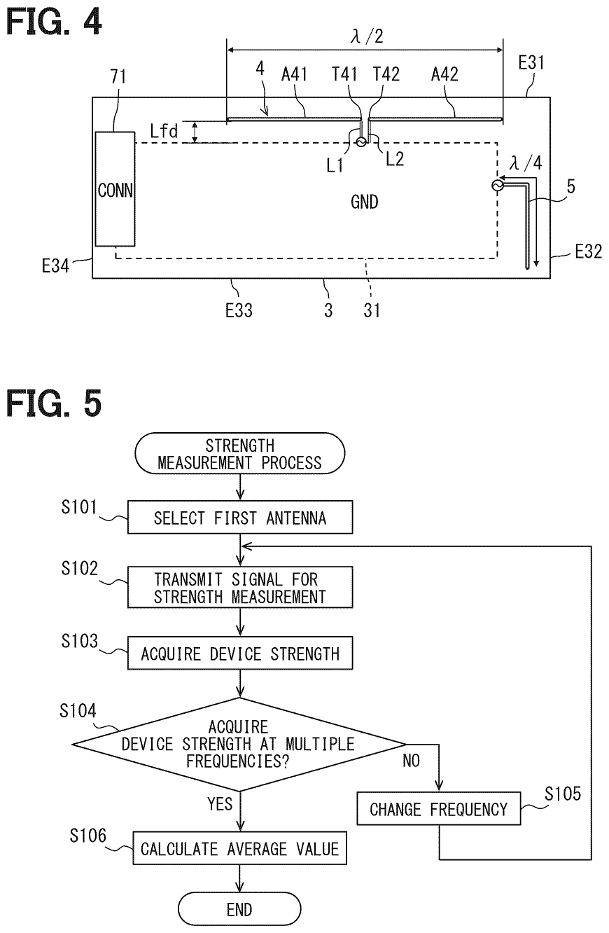

The first antenna 4 may be a dipole antenna having an electrical length of λ/2 as shown in FIG. 4. The λ refers to the wavelength of the target radio wave that the antenna is intended to transmit and receive. Since the target radio wave here is 2.4 GHz, λ in a vacuum corresponds to approximately 125 millimeters. The electric length is an effective length in consideration of effects of a wavelength shortening effect of a dielectric, and the like. The electric length may be called an effective length. The actual dimension at which the electrical length becomes λ/2 may vary depending on the material of the board 3, and the like. In this example, 72 millimeters corresponds to λ. Therefore, the length corresponding to λ/2 is 36 millimeters, and the length corresponding to λ/4 is 18 millimeters.

The first antenna 4 is patterned on the first surface in a position parallel to a first edge E31 of the board 3. The first antenna 4 is formed in a straight line, for example. That is, the first antenna 4 is formed so as to fit along the first edge E31. The configuration shown in FIG. 4 corresponds to a configuration in which the first antenna 4 is provided along the longitudinal direction of the board 3. In FIG. 4, the switch 6, the transmission reception unit 8, and the controller 9 are omitted.

The first antenna 4 includes a feed element A41 and a ground element A42 as its subdivided components. The feed element A41 and the ground element A42 are each a linear conductor having a length of λ/4. The feed element A41 and the ground element A42 are arranged on the same straight line with a predetermined distance therebetween. In the present disclosure, of the two ends of the linear feed element A41, the end closest to the ground element A42 is referred to as a feed end T41. Of the two ends of the linear ground element A42, the end closest to the feed element A41 is referred to as a ground end T42. The distance between the feed end T41 and the ground end T42 can be designed as appropriate, for example, to be 1 millimeter, 2 millimeters, or 4 millimeters.

The feed element A41 is electrically connected to the transmission reception unit 8 via the feed line L1, the switch 6, and the like. The feed line L1 is a microstrip line for feeding power to the feed element A41. One end of the feed line L1 is connected to the feed element A41 at the feed end T41. The other end of the feed line L1 is electrically connected to a signal input output terminal of the transmission reception unit 8.

The ground element A42 is connected to the ground layer 31 via a ground line L2 that extends from the ground end T42 toward the ground layer 31. The ground line L2 is a microstrip line for connecting the ground element A42 to the ground layer 31. The feed line L1 and the ground line L2 are formed in parallel to each other. Moreover, the feed line L1 and the ground line L2 have the same length. The first antenna 4 has a shape in which a feed element A41 and a ground element A42 extend from the ends of the feed line L1 and the ground line L2, and the directions are opposite. In the figure, Lfd indicates the power supply line length, which is the length of the feed line L1 and the ground line L2. In the present embodiment, as an example, Lfd is set to 8 millimeters. The length of the feed line may be 5 millimeters, 7 millimeters, 10 millimeters, and the like.

The second antenna 5 is an L-shaped linear element having an electrical length of λ/4. The second antenna 5 is configured as an inversion L antenna, which is a variation of a monopole antenna. The second antenna 5 is patterned on the first surface with its polarization plane perpendicular to that of the first antenna 4. The second antenna 5 may be patterned on the first surface with a majority of the antenna 5 parallel to the second edge E32 of the board 3. For convenience, the portion of the second antenna 5 that extends along the second edge E32 is referred to as a second edge parallel portion.

The second antenna 5 has a second perpendicular edge portion extending at a right angle from one end of the second parallel edge portion. The second antenna 5 has an overall L-shape formed by the second edge perpendicular portion and the second edge parallel portion. The second edge parallel portion may be set to 28 millimeters, and the second edge perpendicular portion may be set to 8 millimeters, for example. The second antenna 5 only needs to have a total length of substantially λ/4 (=36 millimeters), and the ratio of the length of the second edge parallel portion to the length of the second edge perpendicular portion can be appropriately adjusted.

The longer the second edge parallel portion is, the easier it becomes for the second antenna 5 to transmit and receive radio waves perpendicular to the first antenna 4 in terms of the plane of polarization. According to the above antenna arrangement, the polarization plane of the second antenna 5 is perpendicular to the polarization plane of the first antenna 4. The second antenna 5 is provided at a position spaced apart from the first antenna 4 by λ/8 or more.

The vehicle interior communication unit 7 is a circuit module for communicating with the smart ECU 1 via the communication cable C. The vehicle interior communication unit 7 includes analog circuit elements and ICs, a PHY chip that complies with a communication method for communicating with the smart ECU 1, and a connector 71 to which a communication cable C is connected. The vehicle interior communication unit 7 corresponds to a cable connection unit. The connector 71 is placed along the fourth edge E34 of the board 3.

The transmission reception unit 8 is a circuit module that performs signal processing related to the transmission and reception of radio signals. The transmission reception unit 8 may include a modulation circuit, a demodulation circuit, a frequency conversion circuit, an amplifier circuit, a local oscillator, and the like. The transmission reception unit 8 also includes an input output terminal for outputting a signal to an antenna and receiving a signal from the antenna. The transmission reception unit 8 is connected to the controller 9 so as to be able to communicate with each other. The transmission reception unit 8 demodulates the data signal received by the antenna in use and provides it to the controller 9. A data signal refers to a modulated signal for data communication. Furthermore, the transmission reception unit 8 modulates transmission data input from the controller 9 and radiates the modulated data as radio waves from the antenna in use. The transmission reception unit 8 may be implemented as an IC chip (i.e., a transmission reception IC).

The transmission reception unit 8 also includes an automatic gain control (AGC) circuit that performs automatic gain control on the reception signal. The transmission reception unit 8 is configured to use the received voltage at the first antenna 4 as a reference voltage for automatic gain control. The transmission reception unit 8 includes an input terminal for AGC. The input terminal for automatic gain control is electrically connected to the feed line L1. In other words, the transmission reception unit 8 is configured to use the reception voltage at the first antenna 4 as the reference voltage for AGC.

Furthermore, the transmission reception unit 8 is configured to transmitting a CW signal of a use frequency in addition to a modulated signal for data communication. The use frequency used refers to the frequency (channel) used for communication. The use frequency may be interpreted as the carrier frequency. The use frequency changes over time by frequency hopping or in response to an instruction from the controller 9.

The transmission reception unit 8 includes a phase detection unit 81 as a functional unit for distance measurement. The phase detection unit 81 is a circuit that detects the reception phase, which is the phase angle of the reception signal relative to the output signal of the local oscillator, when the CW signal is received. The transmission reception unit 8 provides the detection value of the reception phase of the CW signal to the controller 9 in association with information indicating the use frequency (for example, a channel number). Each time the use frequency is switched, the transmission reception unit 8 detects the transmission and reception phases of the CW signal as part of the distance measurement process for that frequency. That is, the controller 9 is provided with data indicating the reception phase for each frequency.

The controller 9 is a microcomputer that controls the transmission reception unit 8 and the switch 6. The controller 9 includes a processor 91, a memory 92, a storage 93, and an I/O circuit. The controller 9 is connected to each of the transmission reception unit 8, the vehicle interior communication unit 7, and the switch 6. The controller 9 corresponds to a control module.

The controller 9 plays a role in controlling the exchange of data with the smart ECU 1. Specifically, the controller 9 provides the received data input from the transmission reception unit 8 to the smart ECU 1 sequentially or upon request from the smart ECU 1. In addition, the controller 9 outputs the transmission data input from the smart ECU 1 to the transmission reception unit 8.

The controller 9 includes, as functional units related to distance measurement, an antenna selection unit F1, a phase acquisition unit F2, a phase difference acquisition unit F3, a distance acquisition unit F4, a device strength acquisition unit F5, and a report processing unit F6.

The antenna selection unit F1 is configured to output a predetermined control signal to the switch 6 to switch the use antenna. The controller 9 performs communication for distance measurement with the mobile device Md at multiple frequencies every time the use antenna is switched, thereby acquiring distance information and device strength for each antenna and frequency.

The phase acquisition unit F2 is configured to acquire a primary phase difference for each frequency. The primary phase difference is the phase difference between the CW signal transmitted from the antenna in use and the CW signal received. The primary phase difference can be called the transmission reception phase difference or the single frequency phase difference. The primary phase difference is, for example, an average or total value of reception phases detected by the wireless device 2 and the mobile device Md when the wireless device 2 and the mobile device Md transmit and receive CW signals to each other. The phase acquisition unit F2 may be rephrased as a primary phase difference determination unit.

The phase acquisition unit F2 can specify a primary phase difference at the frequency used by using any one of a variety of methods, such as an active two-way method, a passive two-way method, or a one-way method. The active two-way system, the passive two-way system, and the one-way system will be described in detail later. The mobile device Md operates in a manner compatible with the method for identifying the primary phase difference used by the wireless device 2. In the present embodiment, as an example, it is assumed that an active two-way system is adopted.

The phase acquisition unit F2 can execute a process for acquiring the primary phase difference each time the frequency used is switched. When the active two-way system is employed, the process includes transmitting and receiving CW signals to and from the mobile device Md, and receiving a message indicating the reception phase from the mobile device Md. The communication for acquiring the primary phase difference corresponds to an example of distance measurement communication. The value of the primary phase difference acquired by the phase acquisition unit F2 is stored in the memory 92 in association with the value of the use frequency at that time. The calculation of the primary phase difference may be performed by the transmission reception unit 8. The functional layout within the wireless device 2 can be changed as appropriate.

The phase difference acquisition unit F3 is configured to calculate a secondary phase difference. The secondary phase difference is the difference between the primary phase differences observed at two different frequencies. The secondary phase difference can be called a two-frequency phase difference or an inter-frequency phase difference. The secondary phase difference corresponds to a displacement amount of a transmission and reception phase angle due to a change in frequency. Since the primary phase difference itself is a parameter different from the reception strength, the secondary phase difference is also a parameter different from the reception strength. The phase difference acquisition unit F3 may be rephrased as a secondary phase difference acquisition unit.

The phase difference acquisition unit F3 calculates the secondary phase difference for each combination of frequencies. In BLE communication, three or more frequencies are used over time, so the phase difference acquisition unit F3 calculates two or more secondary phase differences having different combinations of frequencies, that are multiple secondary phase differences. In the present disclosure, the multiple secondary phase differences may be referred to as multi-frequency phase differences. As described next, the distance acquisition unit F4 estimates the device distance based on the multi-frequency phase difference. The device distance is the distance from the wireless device 2 to the mobile device Md.

The distance acquisition unit F4 executes a process of calculating a provisional value of the device distance for each combination of frequencies for which the secondary phase difference is calculated, using the differential frequency (Δf) which is the difference between the two frequencies, and the secondary phase difference (Δφ). When the device distance is D, then there is a relationship between D, Δf, and Δφ: D∝C·Δφ/(2π·Δf). The parameter “C” in the above expression indicates the propagation speed of radio waves (3×10\hat{ }8 m/sec). The distance acquisition unit F4 calculates a provisional value of the device distance based on the relational expression. The provisional value of the device distance may be calculated using the following first equation below. The parameter k in the first equation is a design value and is set to 1.0 or 0.5. The value of k can be determined depending on whether the transmission reception phase difference is calculated as the amount of phase change for one way or for both ways.

D=k·C·Δφ/(2π·Δf) First Equation

The distance acquisition unit F4 adopts the average value or the median value of the provisional values of the device distances calculated for each combination of frequencies as the device distance for the use antenna. For convenience, the device distance calculated using the first antenna 4 is referred to as the first distance, and the device distance calculated using the second antenna 5 is referred to as the second distance. The distance acquisition unit F4 can adopt the average value of the first distance and the second distance as the final value of the device distance.

The device strength acquisition unit F5 acquires the reception strength at the mobile device Md of a signal transmitted from the use antenna, that is, the device strength, by communicating with the mobile device Md. The device strength acquisition unit F5 may acquire the device strength from the mobile device Md by transmitting a message requesting a report of the device strength to the mobile device Md. In that case, the mobile device Md may transmit a device strength message based on receiving a request from the wireless device 2. Every time the usage frequency changes, the device strength acquisition unit F5 acquires the device strength at that frequency. The signal that the mobile device Md uses to measure the reception strength may be the CW signal or data signal.

Incidentally, since the second antenna 5 is the monopole antenna, the leakage current into the communication cable C during signal transmission is relatively large. When the leakage current to the communication cable C is large, inversion of the reception strength may occur due to noise radiated from the communication cable C toward the interior of the vehicle. In other words, the device strength for the signal transmitted from the second antenna 5 is not a reliable criterion for determining the device position. For this reason, the device strength acquisition unit F5 of the present embodiment acquires the device strength only when the first antenna 4 is in use. That is, the device strength acquisition unit F5 collects only the first antenna strength, which is the device strength for the signal transmitted from the first antenna 4.

The mobile device Md may transmit a device strength message every time it receives a predetermined signal from the wireless device 2. In that case, the controller 9 may receive a message indicating not only the first antenna strength but also a second antenna strength, which is the device strength for signals transmitted from the second antenna 5. The device strength acquisition unit F5 may initially acquire the device strength for each antenna and each frequency. The device strength acquisition unit F5 may be configured to collect substantially only the first antenna strength by deleting or ignoring data regarding the second antenna strength.

The report processing unit F6 is configured to transmit a data set including reception strength information and device distance information determined as a result of the strength measurement process and distance measurement process to the smart ECU 1 as communication status data. The reception strength information includes data on the strength of the first antenna. The device distance information includes an average value of the first distance and the second distance, or data about each of the first distance and the second distance. The reception status data is used by the smart ECU 1 to determine the device position. The report processing unit F6 may transmit the reception strength information and the device distance information to the smart ECU 1 as separate packets.

Each wireless device 2 operates according to instructions from the smart ECU 1. Each wireless device 2 sequentially executes the strength measurement process and distance measurement process based on instructions from the smart ECU 1. In other words, each wireless device 2 outputs data related to the device strength and device distance to the smart ECU 1 based on an instruction from the smart ECU 1. Each wireless device 2 may be configured to autonomously attempt the strength measurement process and the distance measurement process at a predetermined interval.

In addition, the wireless device 2 changes its operating state based on an instruction from the smart ECU 1. The power of the wireless device 2 is switched on and off based on an instruction from the smart ECU 1.

### Strength Measurement Process

Here, the strength measurement process will be described with reference to FIG. 5. The controller 9 executes the strength measurement process based on an instruction from the smart ECU 1. In addition, the controller 9 may execute the strength measurement process voluntarily upon receiving a predetermined user operation (for example, an unlocking operation) without receiving an instruction or permission from the smart ECU 1. Furthermore, the controller 9 may periodically execute the strength measurement process. The strength measurement process includes, for example, processes S101 to S106. Each process is executed in sequence according to the direction of the arrows shown in the figure.

The process of S101 is a process of setting the first antenna 4 as the antenna to be used. The process of S102 is a process of causing the first antenna 4 to transmit a strength measurement signal. The strength measurement signal may be a predefined message requesting a device strength report. Furthermore, as described later, a CW signal for distance measurement may be used as a signal for measuring the strength.

The process of S103 is a process of receiving a device strength message from the mobile device Md to acquire the device strength as the first antenna strength. The process of S104 is a process of determining whether the first antenna strength has been acquired at a predetermined number (N) of frequencies. The N can be set to 3, 6, 10, and the like. When the number of frequencies at which the first antenna strength has been obtained does not reach the predetermined number (NO in S104), the controller 9 executes the process of S105.

The process of S105 is a process for changing the use frequency. For example, the controller 9 switches the use frequency after transmitting a message indicating the next use frequency to the mobile device Md. When the use frequency is changed, the controller 9 executes the process of S101 and subsequent processes at the new use frequency. That is, the processes of S101 to S105 are repeated until the number of frequencies for which device strengths have been acquired reaches a predetermined number. The use frequency may be changed automatically by frequency hopping.

When the first antenna strengths at a predetermined number of frequencies or more have been acquired, the controller 9 executes the process of S106. The process of S106 is a process of calculating a representative value of the first antenna strength for each frequency as the report strength. The representative value of the first antenna strength for each frequency, in other words, the report strength, may be the average value or the median value of multiple first antenna strengths. The report strength is the device strength for reporting to the smart ECU 1. The smart ECU 1 uses the device strength reported from each wireless device 2 as information for determining whether the mobile device Md is present inside the vehicle. Therefore, the report strength can also be called the strength for determining the position.

The process of S104 may be a process of determining whether the device strength has been acquired for each of all frequencies (Ch 0 to 36) that can be used for data communication. In that case, the N may be set to 37. The process of S104 may also be a process of determining whether device strength has been acquired for each of all frequencies (Ch 37 to 39) used in advertising. In that case, the N may be set to 3.

### Distance Measurement Process

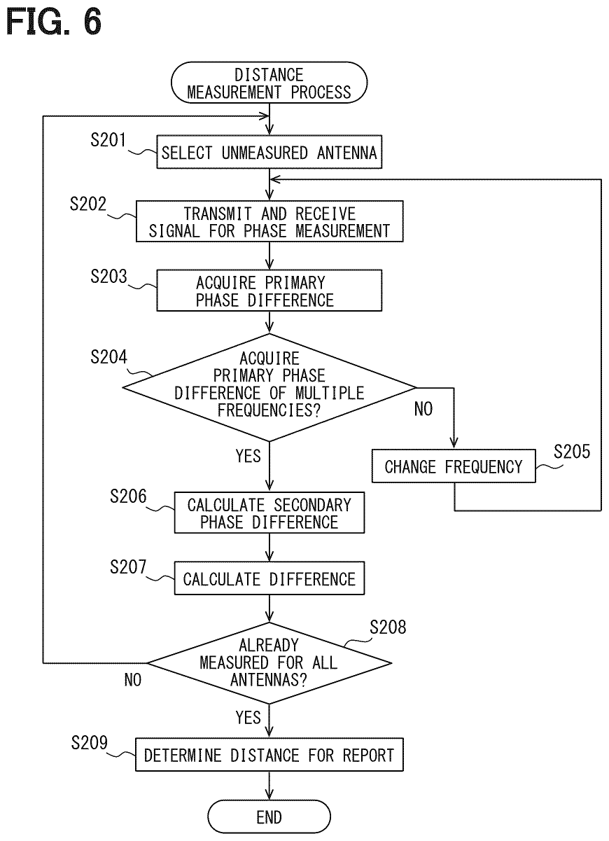

Here, the distance measurement process will be described with reference to FIG. 6. The controller 9 executes the distance measurement process based on instructions from the smart ECU 1. In another aspect, the controller 9 may execute the distance measurement process autonomously upon receiving a specific user operation (for example, an unlocking operation) without receiving instructions or permission from the smart ECU 1. Furthermore, the controller 9 may periodically execute the distance measurement process. In addition, the controller 9 may execute the strength measurement process and the distance measurement process in sequence. Furthermore, the controller 9 may execute the strength measurement process and the distance measurement process in parallel. The distance measurement process includes, for example, processes of S201 to S209. The controller 9 executes each process in sequence according to the directions of the arrows shown in FIG. 6.

The process of S201 is a process of setting an antenna whose device distance has not yet been measured as the use antenna. An antenna for which the device distance has not been measured corresponds to an antenna for which processes S202 to S207 have not been executed.

The process of S202 is a process of transmitting and receiving a phase measurement signal to and from the mobile device Md. The phase measurement signal may be a CW signal at the currently use frequency. Furthermore, the phase measurement signal may be any other predetermined signal. The process of S203 is a process of acquiring the primary phase difference. The wireless device 2 of the present embodiment attempts to identify the primary phase difference using an active two-way system. Therefore, the process of S203 may include receiving a reception phase message from the mobile device Md. As described above, the wireless device 2 may determine the primary phase difference using a passive two-way system or a one-way system. When the wireless device 2 is configured to acquire the primary phase difference using the one-way system, processes S202 to S203 may be a process in which the mobile device Md transmits the CW signal while sequentially changing the frequency, and the wireless device 2 specifies the reception phase for each frequency. The processes S202 and S203 are a series of processes for specifying the primary phase difference. Details of processes S202 and S203 can be changed as appropriate depending on the method for identifying the primary phase difference. The communication executed in processes S202 and S203 corresponds to distance measurement communication.

The process of S204 is a process for determining whether primary phase differences have been collected at a predetermined number (M) of frequencies. The M is set to a value equal to or greater than 3, such as 3, 6, or 10. The M may be the same value as N described above, or may be different. When the number of frequencies for which the primary phase difference has been identified does not reach the predetermined number (NO in S204), the controller 9 executes the process of S205.

The process of S205 is a process for switching the use frequency, similar to the process of S105. The change of frequency may be by frequency hopping. After the use frequency is changed, the controller 9 executes the process of S202 and subsequent processes at the new use frequency. That is, the controller 9 repeats processes of S202 to S205 until the number of frequencies for which the primary phase difference has been measured reaches a predetermined number.

The process of S204 may be a process of determining whether the primary phase difference has been measured at each of all frequencies (Ch 0 to 36) that can be used for data communication. The process of S204 may also be a process of determining whether the primary phase difference has been measured at each of all frequencies (Ch 37 to 39) used in advertising.

The process of S206 is a process of calculating secondary phase differences for combinations of multiple frequencies based on the primary phase differences for each frequency collected in processes S202 to S205. Since the primary phase differences at at least three frequencies have been acquired by the sequence of processes S202 to S205, two or more secondary phase differences are generated in the process of S206. The secondary phase difference for each combination of frequencies is stored in the memory 92 together with the frequency information.

The process of S207 is a process in which the distance acquisition unit F4 calculates the device distance based on the currently used antenna. Specifically, the distance acquisition unit F4 calculates a provisional value of the device distance for each combination of frequencies using the above first equation based on multiple secondary phase differences. Then, the average or median of these provisional values is stored in the memory 92 as the device distance for the use antenna.

The process of S208 is a process for determining whether the processes of S202 to S207 have been executed for all antennas provided in the wireless device 2. When there are any antennas remaining for which the above process has not been executed, the process of S201 and the subsequent processes are executed again. When the controller 9 has calculated the device distances for all antennas (YES in S208), it executes a process of S209. The process of S209 determines a device distance to be reported based on the device distance for each antenna. The device distance to be reported refers to the device distance to be reported to the smart ECU 1. The controller 9 may take the average or median of the device distances for each antenna as the device distance for reporting.

### Additional Information on Intercommunication Between Mobile Device and Communication Device

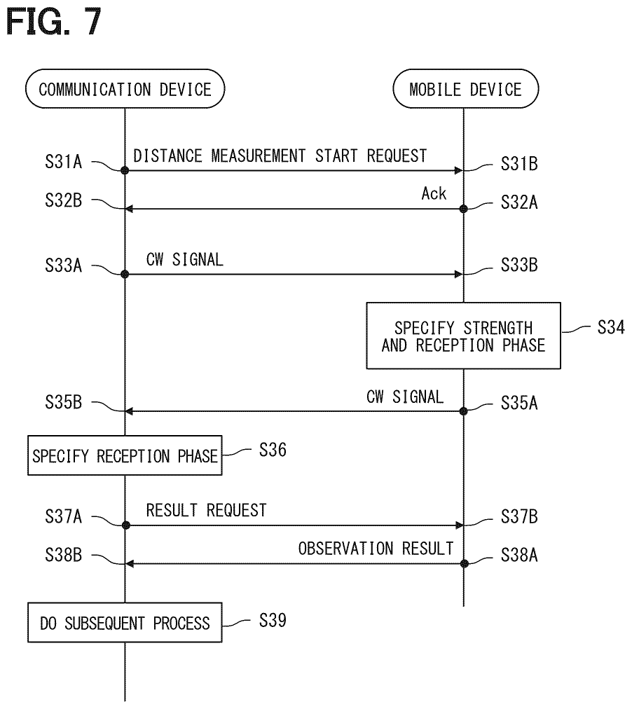

The strength measurement process may be executed as part of the distance measurement process as shown in FIG. 7. When the wireless device 2 receives a request to report the communication status from the smart ECU 1, the wireless device 2 and the mobile device Md may execute a sequence including processes S31A to S39 in FIG. 7. The sequence in FIG. 7 can be performed for each antenna included in the wireless device 2.

The process of S31A is a process in which the wireless device 2 transmits a distance measurement start request signal to the mobile device Md using any one of the antennas. The distance measurement start request signal is a message signal requesting the start of the distance measurement process. Upon receiving the distance measurement start request signal (S31B), the mobile device Md returns an affirmative response signal (so-called Ack) (S32A).

Upon receiving the Ack from the mobile device Md (S32B), the wireless device 2 transmits the CW signal of the currently use frequency (S33A). When the mobile device Md receives the CW signal (S33B), it analyzes the received CW signal to acquire the reception strength and reception phase (S34), and also returns the CW signal (S35A).

When the wireless device 2 receives the CW signal (S35B), it analyzes the received CW signal to specify the reception phase (S36). Moreover, the wireless device 2 transmits an observation value request signal to the mobile device Md (S37A). The observation value request signal is a signal that requests transmission of the reception phase and device strength specified in S34. Upon receiving the observation value request signal (S37B), the mobile device Md returns an observation result signal including the device strength and the reception phase (S38A). When the wireless device 2 receives the observation result signal (S38B), as a subsequent process, it attempts to calculate a device strength and a device distance to be reported, using the reception phase and the device strength in the reception signal (S39). The subsequent process may include changing frequencies, changing antennas, and the like. The processes of S31A to S39 are repeatedly executed while changing the antenna and frequency used so that the device strength and device distance for reporting can be calculated.

The mobile device Md may transmit a message including the device strength to the wireless device 2 regardless of whether the source of the received CW signal is the first antenna 4. The wireless device 2 may discard or ignore the device strength acquired while the second antenna 5 is in use. The expression of “ignore” here means not using it in calculating the device strength for reporting. Moreover, the wireless device 2 may specify, in the observation value request signal, whether a report of the device strength is required. The wireless device 2 may transmit a signal requesting both the receiving phase and the device strength when the first antenna 4 is in use, but may transmit a signal that does not request the device strength when the second antenna 5 is in use.

Furthermore, when a passive two-way system is adopted as a system for identifying the transmission and reception phase difference, there is no need for the mobile device Md to return the reception phase. Instead, the mobile device Md can return the CW signal reflecting the reception phase to the wireless device 2, as described later.

### Position Determination Process

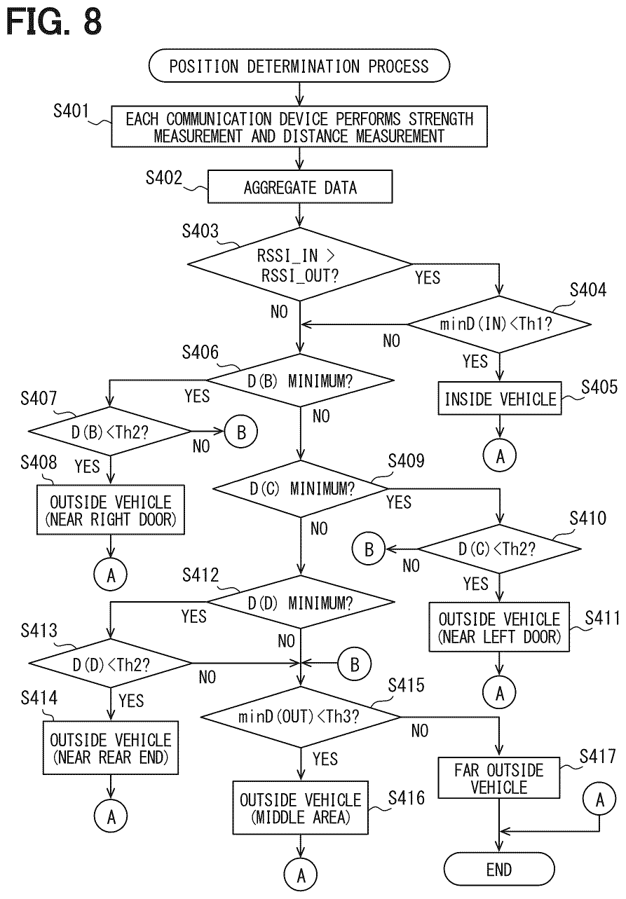

Here, the position determination process executed by the in-vehicle system VS (mainly the smart ECU 1) will be described with reference to the flowchart shown in FIG. 8. The position determination process may include processes S401 to S417 as shown in FIG. 8. The in-vehicle system VS may execute the position determination process in response to a user operation such as an unlocking operation or a locking operation. The in-vehicle system VS may periodically execute the position determination process. The in-vehicle system VS may execute the position determination process periodically or in response to a predetermined user operation, on condition that the gateway communication device is communicatively connected to the mobile device Md.

In the process of S401, each wireless device 2 executes the strength measurement process and distance measurement process in a predetermined order. The process of S401 can be understood as a process in which the smart ECU 1 causes each wireless device 2 to execute the strength measurement process and the distance measurement process in a predetermined order. The process of S402 is a process in which each of the multiple wireless devices 2 transmits communication status data to the smart ECU 1. The process of S402 can be interpreted as a process of aggregating communication status data for each wireless device 2 in the smart ECU 1. The process of S403 is a process in which the smart ECU 1 determines whether the indoor device strength is greater than the outdoor device strength. In the figure, RSSI_IN means the indoor device strength. Also, RSSI_OUT means the outdoor device strength.

The indoor device strength (RSSI_IN) is the reception strength observed by the mobile device Md for a signal transmitted from the indoor device. In the present embodiment, since the only indoor device is the wireless device 2A, the device strength provided by the wireless device 2A corresponds to the indoor device strength. When there are multiple indoor devices, the smart ECU 1 can handle the maximum value of the device strength provided by the multiple indoor devices as the indoor device strength. When there are multiple indoor devices, the indoor device strength may be the average value or median value of the device strength provided by the multiple indoor devices.

The outdoor device strength (RSSI_OUT) is the reception strength observed by the mobile device Md for the signal transmitted from the outdoor device. In the present embodiment, the smart ECU 1 is connected to the wireless devices 2B to 2D as the outdoor devices. In such a case, the smart ECU 1 treats the maximum value of the device strength provided by the multiple outdoor devices as the indoor device strength. That is, the smart ECU 1 of the present embodiment regards the maximum value of the device strength provided by the wireless devices 2B to 2D as the outdoor device strength. When there are multiple outdoor devices, the outdoor device strength may be the average value or median value of the device intensities provided by the multiple outdoor devices.

As described above, the device strength reported by each wireless device 2 to the smart ECU 1 is the reception strength when a signal is transmitted from the first antenna 4, and is not the reception strength when a signal is transmitted from the second antenna 5. When the second antenna 5 is in operation, the device strength may be affected by leakage current from the communication cable C, but when the first antenna 4 is in operation, the possibility of this is relatively small. The above configuration corresponds to a configuration in which it is determined whether the mobile device Md is present inside the vehicle without using the reception strength when the second antenna 5 is in operation. The term “device strength” in the description of the position determination process can be read as “first antenna strength.”

When the indoor device strength is greater than the outdoor device strength (YES in 403), the smart ECU 1 executes the process of S404. The process of S404 is a process for determining whether the minimum value of an indoor device observation distance is less than a predetermined indoor determination value. The indoor device observation distance is the device distance observed by the indoor device. In the present embodiment, the only indoor device is wireless device 2A, so the device distance observed by wireless device 2A corresponds to the minimum value of the indoor device observation distance. When multiple indoor devices are present, the minimum indoor device observed distance can be the minimum device distance observed by the multiple indoor devices. In FIG. 8, minD (IN) represents the minimum value of the indoor device observation distance. Th1 in FIG. 8 is an indoor determination value. The indoor determination value may be set to 2 meters, 2.5 meters, 3 meters, and the like.

When the indoor device observation distance is less than the indoor determination value (YES in S404), the smart ECU 1 determines that the device position is inside the vehicle (S405). The processes of S403 to S405 corresponds to the smart ECU 1 determining that the device position is inside the vehicle based on the presence of an indoor device whose device distance is less than the indoor determination value and the indoor device strength is greater than the outdoor device strength.

When the indoor device strength is equal to or less than the outdoor device strength (NO in S403), the smart ECU 1 executes a process of S406. Furthermore, even in a case where the indoor device strength is greater than the outdoor device strength, when there is no indoor device whose device distance is less than the indoor determination value, the smart ECU 1 may execute the process of S406.

The process of S406 is a process for determining whether the device distance observed by the wireless device 2B (i.e., the right outdoor device) placed on the right exterior surface of the vehicle Hv is the smallest among the device distances observed by multiple outdoor devices. Hereinafter, the device distance reported from the wireless device 2B will be referred to as the right observation distance. Moreover, the device distance observed by the outdoor device is hereinafter also referred to as the outdoor device observed distance. D(B) in FIG. 8 represents the right observation distance.

When the right observation distance is the shortest among the outdoor device observation distances (YES in S406), the smart ECU 1 executes the process of S407. On the other hand, when the right observation distance is not the shortest among the outdoor device observation distances (NO in S406), the smart ECU 1 executes the process of S409.

The process of S407 is a process for determining whether the right observation distance is less than a predetermined proximity determination value. Th2 in FIG. 8 is the proximity determination value. The proximity determination value is a parameter that defines a passive entry area outside the vehicle. The passive entry area corresponds to an area in which the in-vehicle system VS can automatically unlock/lock the vehicle Hv based on wireless communication with the mobile device Md. The proximity determination value may be set to a value equal to or less than 2 meters, such as 1.0 meters, 1.5 meters, or 2 meters. When the right observation distance is less than the proximity determination value (YES in S407), the smart ECU 1 determines that the device position is near the right door outside the vehicle (S408). Even in a case where the right observation distance is the shortest among the outdoor device observation distances, when the right observation distance is equal to or greater than the proximity determination value (NO in S407), the smart ECU 1 can execute the process of S415.

The process of S409 is a process of determining whether the device distance observed by the wireless device 2C (that is, the left outdoor device) placed on the left exterior surface of the vehicle Hv is the shortest among the outdoor device observation distances. Hereinafter, the device distance reported from the wireless device 2C is also referred to as the left observation distance. D(C) in FIG. 8 represents the left observation distance.

When the left observation distance is the shortest among the outdoor device observation distances (YES in S409), the smart ECU 1 executes the process of S410. On the other hand, when the left observation distance is not the shortest among the outdoor device observation distances (NO in S409), the smart ECU 1 executes the process of S412.

The process of S410 is a process of determining whether the left observation distance is less than the proximity determination value. When the left observation distance is less than the proximity determination value (YES in S410), the smart ECU 1 determines that the device position is outside the vehicle and near the left door (S411). When the left observation distance is greater than or equal to the proximity determination value (NO in S410), the smart ECU 1 executes the process of S415.

The process of S412 is a process of determining whether the device distance observed by the wireless device 2D (in other words, the rear outdoor device) placed on the rear external surface of the vehicle Hv is the smallest among the outdoor device observation distances. Hereinafter, the device distance reported from the wireless device 2D will also be referred to as the rear observation distance. D(D) in FIG. 8 represents the rear observation distance.

When the rear observation distance is the shortest among the outdoor device observation distances (YES in S412), the smart ECU 1 executes the process of S413. On the other hand, when the rear observation distance is not the smallest among the outdoor device observation distances (NO in S412), the smart ECU 1 executes the process of S415.

The process of S413 is a process of determining whether the rear observation distance is less than a proximity determination value. When the rear observation distance is less than the proximity determination value (YES in S413), the smart ECU 1 determines that the device position is near the rear end outside the vehicle (for example, trunk door) (S414).

The process of S415 is a process of determining whether the minimum value of the outdoor device strength is smaller than a predetermined distant determination value. In the figure, minD (OUT) represents the minimum value of the outdoor device strength. The distant determination value is a parameter for determining that the mobile device Md is not present near the vehicle Hv. The distant determination value may be set to 5.0 meters, 6.0 meters, 10 meters, or the like.

The distant determination value can be understood as a parameter that defines a middle area placed between the vicinity of the vehicle and the distant position in one aspect. The middle area may be a so-called welcome area in which, upon entry of the mobile device Md into the area, a predetermined welcome control such as turning on the exterior lights is executed. The middle area may be an area where a predetermined control, which is not executed in a state where the mobile device Md is placed far outside the vehicle, is executed/started. The predetermined control may be authentication via wireless communication with the mobile device Md, tracking of the device position, or shortening of the position determination period. The middle area may also be called a standby area or a peripheral area. Alternatively, the middle area may be an area where the user can use the function of remotely parking/pulling the vehicle Hv.

When the minimum value of the outdoor device strength is smaller than a predetermined distant determination value (YES in S415), the smart ECU 1 determines that the device position is in the middle area outside the vehicle (S416). On the other hand, when the minimum value of the outdoor device strength is equal to or greater than a predetermined distant determination value, the smart ECU 1 determines that the device position is in the distant area outside the vehicle.

### About Calculation Method for Primary Phase Difference

Here, an outline of an active two-way system, a passive two-way system, and a one-way system will be described as examples of a method for calculating the primary phase difference.

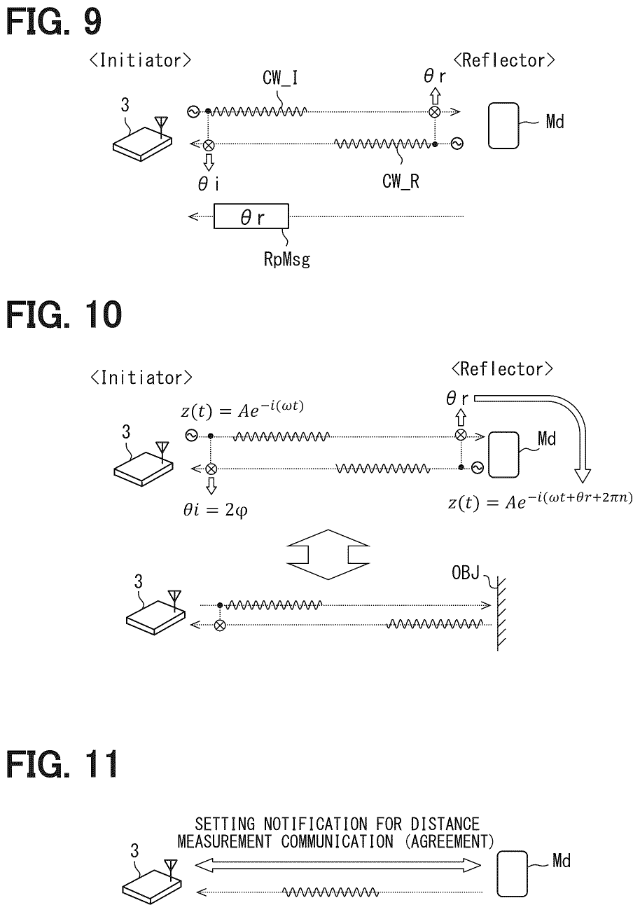

First, the active two-way system will be described. In the active two-way system, as shown in FIG. 9, an initiator and a reflector transmit and receive CW signals to each other, and each detects the phase difference between the transmission signal and the reception signal. The initiator then collects the phase differences observed at the reflectors and determines the primary phase difference. The active two-way method includes a process of transmitting and receiving CW signals to and from each other, and a process of transmitting a reception phase message indicating the reception phase (θr) observed by the reflector to the initiator.

The initiator is a device that starts communication, in other words, a device that requests a response. The reflector is a device that returns a response. Here, the wireless device 2 corresponds to the initiator, and the mobile device Md corresponds to the reflector. The reflector may also be called a responder. In another aspect, the mobile device Md may act as the initiator.

CW_I shown in FIG. 9 is a CW signal transmitted by the initiator. CW_R is the CW signal transmitted by the reflector. In FIG. 9, RpMsg indicates the reception phase message. When the initial phase of the initiator is δi, the initial phase of the reflector is δr, the primary phase difference that should be observed according to the one-way distance between the initiator and reflector is φ, and the target frequency is f, then the relationships are θr=φ+δi−δr, and θi=φ−δi+δr.

Based on the above relational expressions, the average value of θi and θr is the primary phase difference (φ) obtained by cancelling the initial phase components of the initiator and reflector. The active two-way system corresponds to a system in which the average value of the reception phase at the initiator and the reception phase at the reflector is calculated as the primary phase difference. In this case, since a phase difference due to one-way propagation is assumed, the average value of θi and θr is taken as the primary phase difference. In another aspect, when the phase difference due to the propagation of a round trip is assumed as the primary phase difference, the primary phase difference can be calculated as θi+θr.

The passive two-way system is also a system in which the initiator and the reflector transmit and receive CW signals to and from each other, as shown in FIG. 10. The difference with the active two-way system is that the reflector reflects the reception phase of the CW signal transmitted from the initiator in the initial phase of the transmission signal before transmitting. For example, when the reception phase at the reflector is θr, a CW signal expressed by z(t)=A·exp{−i(ωt+θr+2πn)} is transmitted. The A represents the amplitude. The ω is the angular frequency corresponding to the target frequency (f). The relationship is ω=2Tπf. The n is a natural number. The n corresponds to the interval between when the reflector receives the CW signal and when it transmits the CW signal.

According to the above system, the reception phase observed by the initiator does not include the initial phase component of the reflector. The reception phase observed at the initiator has the same value as that of the CW signal reflected and returned by a reflecting object OBJ such as a wall. As a result, the initiator can calculate the primary phase difference without acquiring the reception phase from the reflector. The passive two-way system has an advantage over the active two-way system in that the reflector does not need to transmit a reception phase message.

The one-way method is a method in which the reception phase of the CW signal transmitted from the mobile device Md is adopted as the primary phase difference as shown in FIG. 11, on the premise that the initial phase of the CW signal for each frequency transmitted from the mobile device Md is constant. In the one-way or two-way system, the initiator and the reflector exchange messages indicating the specifications for performing distance measurement communication prior to transmitting the CW signal for each frequency (in other words, executing the preparation process). The parameters required for implementing the distance measurement communication include the initial phase setting value, the frequency switching interval, the frequency increment (so-called hopIncrement), and the initial frequency. When the one-way system is adopted, a distance measurement setting notification message indicating the above setting values may be transmitted from the mobile device Md to the wireless device 2. The mobile device Md may start transmitting the CW signal based on receiving an Ack from the wireless device 2 in response to the distance measurement setting notification message. Of course, the wireless device 2, rather than the mobile device Md, may determine the specifications for performing the distance measurement communication and transmit the distance measurement setting notification message.

### Description of Effects of Above Configuration

The inventors of the present disclosure conducted strength measurement tests in two patterns to verify the effect of the type of antenna of the outdoor device on the strength inside the vehicle. The first pattern is a pattern in which a dipole antenna is placed on the right door handle. The second pattern is a pattern in which the inverted F antenna is placed on the right door handle. The first pattern corresponds to a configuration in which a dipole antenna is used to measure the device strength. The second pattern corresponds to a configuration using an inverted F antenna for measuring the device strength.

In either pattern, the mobile device Md is placed on the seating surface of the right front seat. The orientation of the antenna inside the right door handle is adjusted so that the polarization plane and main beam direction are approximately the same. Moreover, the test conditions other than the type of antenna, such as the transmission power, the placement location and posture of the mobile device Md, and the wiring path of the communication cable C, are substantially the same. The above test corresponds to a test for verifying how much the device strength when the mobile device Md is present inside the vehicle varies depending on the type of antenna of the outdoor device used for strength measurement.

As a result of the above test, when the dipole antenna was used to measure the device strength, the device strength in the right front seat was reduced by about 12 dB to 18 dB compared to when the inverted F antenna was used to measure the device strength. In other words, it was confirmed that the reception strength of the mobile device Md present in the vehicle can be reduced by about 15 dB on average by using a dipole antenna for device strength measurement. Naturally, the smaller the reception strength of the signal emitted from the outdoor device at the mobile device Md present indoors, the less likely the reception strength inversion phenomenon occurs. The test results indicate that the use of the dipole antenna as the antenna type for the outdoor device can reduce the occurrence possibility of the reception strength inversion phenomenon.

Furthermore, in the monopole antenna and the λ/4 antenna such as the inverted F antenna or the inverted L antenna, the ground layer 31 operates as a grounded element of the dipole antenna. Therefore, when the λ/4 antenna is operated, a current is also induced in the ground layer 31, and a relatively large leakage current may flow in the communication cable C. When the leakage current to the communication cable C is large, the noise emitted from the communication cable C toward the interior of the vehicle cabin may increase the strength inside the vehicle. As a result, the inversion of reception strength is likely to occur. In other words, the device strength for the signal transmitted from the second antenna 5 configured as the λ/4 antenna is unreliable as a criterion for determining the device position.

The configuration of the present disclosure was created based on the above findings and considerations. The in-vehicle system VS of the present disclosure determines whether the mobile device Md is present inside the vehicle by using only the first antenna strength out of the first antenna strength and the second antenna strength (S403). That is, the smart ECU 1 does not use the second antenna strength to determine whether the mobile device Md is present inside the vehicle. This is because, as described above, the second antenna strength is unreliable as a criterion for determining whether the mobile device Md is present inside the vehicle. With this configuration, it is possible to reduce the possibility of erroneous determination of the device position due to radio waves resulting from leakage current from the communication cable C connected to the outdoor device.

Incidentally, when a linear conductor having a length of λ/4 is connected to the ground layer 31 in addition to the first antenna 4, resonance may occur in the linear conductor due to a small amount of induced current flowing in the ground layer 31 at the time of operation of the first antenna 4. When the second antenna 5 is also a dipole antenna, resonance may occur in the ground element of the second antenna 5 at the time of operation of the first antenna 4. At the time of operation of the first antenna 4, when resonance occurs in another linear conductor connected to the ground layer 31, the leakage current may increase.

To address this difficulty, the second antenna 5 provided in each wireless device 2 is not a dipole antenna but a monopole antenna (specifically, an inverted L antenna). In other words, the second antenna 5 is an antenna that is not connected to the ground layer 31. Therefore, there is little possibility that resonance will occur in the second antenna 5 due to a minute induced current flowing in the ground layer 31 when the first antenna 4 is in operation. Therefore, it is possible to reduce the possibility of the second antenna 5 being excited when the first antenna 4 is in operation. As a result, it is possible to further prevent the leakage current to the communication cable C during operation of the first antenna 4.

Furthermore, in calculating the device distance, the wireless device 2 determines the final device distance based on the device distances calculated by the first antenna 4 and the second antenna 5, respectively. According to this configuration, it is possible to improve the accuracy of distance estimation compared to a configuration in which the device distance measured using only one antenna is directly adopted as the final device distance.

Furthermore, since the second antenna 5 is a λ/4 antenna (specifically, an inverted L antenna), the board size is smaller than in a configuration in which both the first antenna 4 and the second antenna 5 are dipole antennas. By using, among the multiple antennas, the antennas that are not used for measuring the reception strength as λ/4 antennas, it is possible to further reduce the size of the board 3. The λ/4 antenna can be understood as a conductor having a structure in which the path length of a current is λ/4.

In addition, in order to reduce the size of the board and improve the accuracy of determining the device position, the present disclosure includes a configuration in which, in at least the outdoor device, the antenna used to measure the device strength is the half-wavelength antenna, while the antenna not used to measure the device strength is the non-half-wavelength antenna. The half-wave antenna is an antenna having a length half the wavelength (target wavelength: λ) of the radio waves used for communication with the mobile device Md. The half-wave antennas include dipole antennas as well as slot antennas and patch antennas. The first antenna 4 may be a slot antenna or a patch antenna. The half-wave antenna can be understood as a conductor having a structure in which the path length of a current is λ/2.

Moreover, the non-half-wavelength antenna means the λ/4 antenna such as the monopole antenna, the inverted L antenna, or the inverted F antenna. In addition, a zero-order resonance antenna, which is an antenna that utilizes zero-order resonance which is an application technology of metamaterials, can also be included in the non-half-wavelength antenna. The zero-order resonant antenna is a mushroom-shaped antenna that includes a patch portion that is a flat metal conductor arranged opposite the ground layer 31, and a short-circuit portion that electrically connects the center of the patch portion to the ground layer 31. In the zero-order resonance antenna, a desired radio wave is transmitted and received by utilizing parallel resonance caused by the capacitance formed between the ground layer 31 and the patch portion and the inductance of the short-circuit portion. The zero-order resonant antenna may also be called a metamaterial antenna.

The above description of the first antenna can be rephrased as a half-wave antenna or a dual-purpose antenna. The dual-purpose antenna in this context refers to an antenna that is used not only for distance measurement but also for measuring device strength. Also, the above description of the second antenna can be rephrased as a non-half-wave antenna or a dedicated antenna. The expression of “dedicated” here refers to an antenna that is dedicated only to the distance measurement function of device strength measurement and distance measurement. The expression of “dedicated” here means that it is not intended to be used to measure device strength for device position determination. The dedicated antenna may be used for purposes other than strength measurement, such as data communication or wireless authentication.

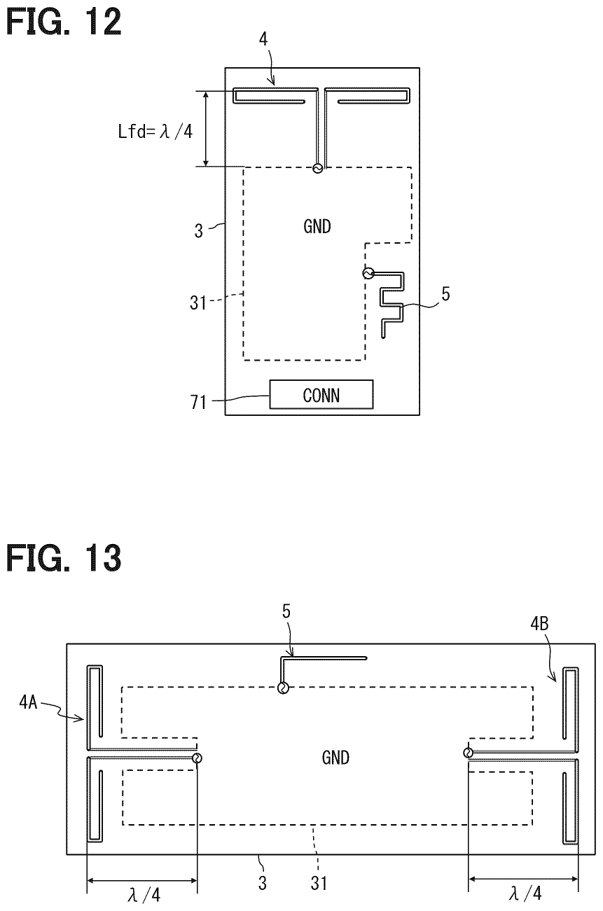

The shapes, mounting positions, and types of the first antenna 4 and the second antenna 5 can be changed as appropriate. The first antenna 4 and the second antenna 5 may have a bent shape as shown in FIG. 12. The bent shape also includes a shape bent in multiple stages. The first antenna 4 may have a folded shape. The second antenna 5 may be formed in a meandering shape.

The feed line length Lfd may be set to a length equivalent to λ/4 (for example, 36 millimeters). According to the configuration in which the feeder line length Lfd is set to λ/4, it is possible to further reduce the amount/probability of current flowing through the ground layer 31 when the first antenna 4 is in operation. When the feed line length Lfd to the first antenna 4 is set to λ/4, the leakage current to the communication cable C can be prevented even in a case where the second antenna 5 is a grounded antenna. The grounded antenna is an antenna that has a portion that is connected to the ground layer 31. The grounded antenna includes the inverted F antenna, the dipole antennas, and the zero-order resonant antenna. Conversely, in the present disclosure, an antenna type that does not have a portion connected to the ground layer 31, such as the monopole antenna or the inverted L antenna, is referred to as an ungrounded antenna.

Additionally, any reference to an element using a designation such as “first,” “second,” and the like, as used in the present disclosure does not generally limit the quantity or order of those elements. These designations may be used in the present disclosure as a convenient method of distinguishing between two or more elements. Thus, reference to first and second elements does not imply that only two elements may be employed. Nor does it imply that the first element must precede the second element in any way.

There may be two first antennas 4, as indicated by reference numerals of 4A and 4B in FIG. 13. The antennas are preferably spaced apart from each other by λ/8 or more. The first antenna 4A and the first antenna 4B may be formed along edges of the board 3 that face each other. According to this configuration, the distance between the first antennas 4A and 4B can be set relatively large. Providing multiple first antennas 4 corresponds to a configuration including multiple half-wavelength antennas. Although FIG. 13 illustrates an example in which both first antennas 4A, 4B are dipole antennas, the types of the multiple first antennas 4 may be different. The first antenna 4B may be a slot antenna or a patch antenna. When multiple dipole antennas are provided as the half-wavelength antenna, the feed line lengths to the dipole antennas may be set to a length equivalent to λ/4. According to this setting, it is possible to further reduce the leakage current to the communication cable C.

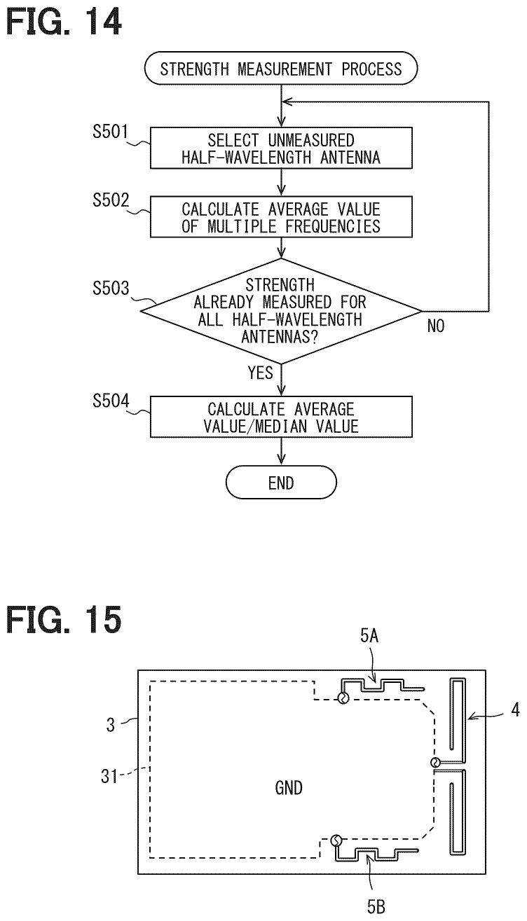

When the wireless device 2 is equipped with multiple half-wave antennas, the controller 9 may measure the device strength for each half-wave antenna as shown in FIG. 14. The process of S501 shown in FIG. 14 is a process in which the controller 9 sets the half-wavelength antenna whose device strength has not yet been measured as the use antenna. The process of S502 is a process of calculating the average or median of the device strength for each frequency using the half-wavelength antenna selected in the process of S501. The contents of the process of S502 may be similar to those of processes S102 to S106. The process of S503 is a process of determining whether the device strength has been measured for all the half-wavelength antennas. When there remains a half-wave antenna whose device strength has not yet been measured, the controller 9 sets the half-wave antenna whose strength has not yet been measured as the use antenna, and then executes the process of S502. The process of S504 is a process of calculating an average of the measured device strength values for each half-wave antenna as the report strength.

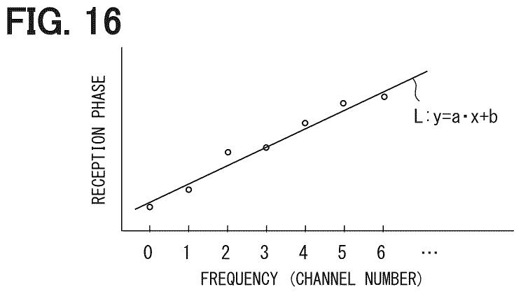

The wireless device 2 may include multiple second antennas 5. As shown in FIG. 15, the board 3 may be provided with second antennas 5A and 5B. In addition, it is preferable that the antennas provided on the board 3 are spaced apart from each other by λ/8 or more. This configuration makes it possible to maintain good isolation between the antennas. In FIGS. 12, 13, and 15, similarly to FIG. 4, the switch 6, the transmission reception unit 8 and the controller 9 are omitted from the illustration. Moreover, the connector 71 is also omitted in FIG. 13 and FIG. 15.

The phase difference acquisition unit F3 does not need to calculate the secondary phase difference for each combination of frequencies individually. The phase difference acquisition unit F3 may calculate a regression line L indicating the relationship between the frequency and the reception phase based on the reception phase for each frequency (that is, the primary phase), and may adopt the slope of the regression line L as the secondary phase difference. FIG. 16 is a diagram conceptually showing the relationship between the regression line L and the reception phase for each frequency. This is because the slope of the regression line L indicates the amount of change in the reception phase relative to the amount of shift in frequency. The regression line L and its slope can be calculated by a variety of methods, such as the least squares method. When the regression line is expressed as y=a·x+b, the coefficient a of x corresponds to the slope of the regression line L. The regression line L can also be called an approximation line. In addition, the phase difference acquisition unit F3 may exclude values (so-called outliers) whose distance from the regression line L provisionally calculated based on the observation values is greater than a predetermined value, and then recalculate the approximation line to determine the secondary phase difference to be used in the distance calculation. According to these configurations, it is possible to increase the accuracy of the secondary phase difference while reducing the processing load on the phase difference acquisition unit F3. This is expected to result in improved distance measurement accuracy.

In the above, the smart ECU 1 determines the device position using the reception strength observed by the mobile device Md. However, the present disclosure is not limited to this. The smart ECU 1 may determine the device position based on the reception strength of the signal received by the first antenna 4 from the mobile device Md. The smart ECU 1 may be configured to treat the reception strength of the signal received by the first antenna 4 from the mobile device Md as the above-described first antenna strength. According to the present configuration, the smart ECU 1 and the wireless device 2 do not need to collect reception strength information for each frequency from the mobile device Md. In addition, since the transmission reception unit 8 is configured to use the received voltage at the first antenna 4 as the reference voltage for the AGC, it is possible to reduce also the possibility of overestimating the reception strength due to noise propagating through the communication cable.

The controller 9 may calculate the device distance using a round-trip time (RTT) instead of or in addition to the transmission reception phase difference. The RTT is the time from when a response request signal is transmitted until when a response signal is received. The RTT and the transmission-reception phase difference correspond to distance-related values. Transmitting and receiving a signal for measuring the RTT also corresponds to an example of distance measurement communication.

The above embodiment is applicable to a variety of vehicles that travel on roads. That is, the present disclosure can be applied to various vehicles capable of traveling on a road, such as a two-wheeled vehicle and a three-wheeled vehicle, in addition to a four-wheeled vehicle. Motorized bicycles may also be included in the two-wheeled vehicles.

The in-vehicle system VS may be configured so that each wireless device 2 operates as a parent device (master) of the mobile device Md using multipoint technology. Furthermore, the in-vehicle system VS may be configured so that each wireless device 2 operates as a child device (slave) of the mobile device Md.

The communication method between the wireless device 2 and the mobile device Md is not limited to BLE, but may be Bluetooth Classic, Wi-Fi (registered trademark), EnOcean (registered trademark), Zigbee (registered trademark), UWB-IR (Ultra Wide Band-Impulse Radio), and the like. A variety of communication methods can be adopted for communication between the wireless device 2 and the mobile device Md. As for Wi-Fi standards, various standards such as IEEE 802.11n and IEEE 802.11ax can be adopted.

### First Note

The present disclosure also includes the following technical ideas. Furthermore, the scope of the present disclosure also includes forms such as a program for causing a computer to function as a controller (control module), and a non-transitory tangible storage medium such as a semiconductor memory on which this program is recorded. The scope of the present disclosure also includes an in-vehicle system including multiple wireless communication devices and a position determination device, as well as a position determination method implemented by a smart ECU.

### Second Note

The various flowcharts shown in the present disclosure are all examples, and the number of processes constituting the flowcharts and the execution order of the processes can be changed as appropriate. In the present disclosure, the term of “acquire” can be read interchangeably as “calculate”, “receive”, or “detect”. The device, system, and method thereof described in the present disclosure may be implemented by a dedicated computer that constitutes a processor programmed to execute one or multiple functions embodied by a computer program. The device and the method described in the present disclosure may be also implemented by a dedicated hardware logic circuit. Further, the device and the method described in the present disclosure may be also implemented by one or more dedicated computers which are constituted by combinations of a processor for executing computer programs and one or more hardware logic circuits. A part or all of the functions of the controller 9 may be implemented as hardware. An aspect in which a certain function is implemented as hardware includes an aspect in which the function is implemented by use of one or more ICs or the like. As the processor (calculation core), a CPU, an MPU, a GPU, a DFP (Data Flow Processor), or the like can be adopted. Some or all of the functions of the controller 9 may be implemented using any of a system-on-chip (SoC), an integrated circuit (IC), and a field-programmable gate array (FPGA). The concept of IC also includes ASIC (Application Specific Integrated Circuit). Further, the computer program may be stored in a computer-readable non-transitionary tangible storage medium as an instruction executed by the computer. As a program storage medium, an HDD (Hard-disk Drive), an SSD (Solid State Drive), a flash memory, or the like can be adopted.

What is claimed is:

1. A wireless communication device that is mounted on an external surface of a vehicle and used for wirelessly communicating with a mobile device, the wireless communication device comprising:
a plurality of antennas; and
a control module configured to control an operation of the plurality of antennas, wherein
the plurality of antennas include:
a first antenna that is a half-wave antenna; and
a second antenna that is not a half-wave antenna, and
the control module is configured to:
acquire a first antenna strength that is a reception strength, at the mobile device, of a wireless signal transmitted from the first antenna;
perform distance measurement communication using the first antenna, the distance measurement communication being communication for measuring a distance-related value that is a parameter different from the reception strength and that takes a value according to a distance to the mobile device;
perform the distance measurement communication using the second antenna; and
calculate a distance to the mobile device based on a first distance-related value obtained in the distance measurement communication using the first antenna and a second distance-related value obtained in the distance measurement communication using the second antenna; and
transmit data indicating the distance to the mobile device to a position determination device mounted on the vehicle in association with data indicating the first antenna strength.

2. The wireless communication device according to claim 1, further comprising
a board including a ground layer,
wherein
the second antenna is not connected to the ground layer.

3. The wireless communication device according to claim 1, wherein
the control module sequentially performs communication for measuring the distance-related value by using each of the plurality of antennas.

4. The wireless communication device according to claim 1, wherein
the control module is configured not to receive data indicating a second antenna strength that is the reception strength, at the mobile device, of a signal transmitted from the second antenna, from the mobile device, or is configured to ignore the data when receiving the data.

5. The wireless communication device according to claim 1, further comprising
a transmission reception unit that
is connected to each of the first antenna and the second antenna by a signal line, and
is configured to perform an automatic gain control on a reception signal,
wherein
the transmission reception unit is configured to use a reception voltage at the first antenna as a reference voltage for the automatic gain control.

6. The wireless communication device according to claim 1, wherein
the first antenna and the second antenna are spaced apart from each other by at least one-eighth of a target wavelength that is a wavelength of radio waves used for communication with the mobile device.

7. The wireless communication device according to claim 1, further comprising
a board including a ground layer,
wherein
the second antenna and the first antenna are placed on the board in a manner that a polarization plane of the second antenna and a polarization plane of the first antenna for transmission and reception are perpendicular to each other.

8. The wireless communication device according to claim 1, wherein
the distance-related value is a phase difference between a continuous wave signal transmitted to the mobile device and the continuous wave signal received from the mobile device, and
the control module is configured to acquire the phase difference at each of a plurality of frequencies.

9. The wireless communication device according to claim 1, wherein
the distance-related value is a round-trip time that is a time from transmitting a response request signal to the mobile device to receiving a response signal from the mobile device.

10. A wireless communication device that is mounted on a vehicle and used for wirelessly communicating with a mobile device, the wireless communication device comprising:
a plurality of antennas; and
a control module configured to control an operation of the plurality of antennas,
wherein
the plurality of antennas include:
a first antenna that is a half-wave antenna; and
a second antenna that is not the half-wave antenna, and
the control module is configured to:
acquire a first antenna strength that is a reception strength, at the mobile device, of a wireless signal transmitted from the first antenna;
perform distance measurement communication for the mobile device to calculate a device distance that is a distance from the mobile device to the wireless communication device for each antenna;
receive, from the mobile device, data indicating the device distance; and
transmit a signal indicating the reception strength and the distance to a position determination device.

11. A wireless communication device that is mounted on an external surface of a vehicle and used for wirelessly communicating with a mobile device, the wireless communication device comprising:
a plurality of antennas; and
a control module configured to control an operation of the plurality of antennas,
wherein
the plurality of antennas include;
a first antenna that is a half-wave antenna; and
a second antenna that is not the half-wave antenna, and
the control module is configured to:
acquire a first antenna strength that is a reception strength of a wireless signal received by the first antenna from the mobile device;
perform distance measurement communication using the first antenna, the distance measurement communication being communication for measuring a distance-related value that is a parameter different from the reception strength and that takes a value according to a distance to the mobile device;
perform the distance measurement communication using the second antenna; and
calculate a distance to the mobile device based on a first distance-related value obtained in the distance measurement communication using the first antenna and a second distance-related value obtained in the distance measurement communication using the second antenna; and
transmit data indicating the distance to the mobile device to a position determination device mounted on the vehicle in association with data indicating the first antenna strength.

12. The wireless communication device according to claim 1, wherein
the wireless communication device is used by being built into an outer door handle, a pillar, a side mirror, a side sill, or a bumper of the vehicle.

13. A board for a wireless communication device mounted on an outer door handle of a vehicle, the board comprising:
a ground layer;
a first antenna that is a half-wave antenna for performing wireless communication with a mobile device;
a second antenna that is an antenna for performing wireless communication with a mobile device of a type different from the first antenna, and is an ungrounded antenna that does not have a portion electrically connected to the ground layer; and
a control module configured to control an operation of a plurality of antennas,
wherein
the control module includes:
a strength acquisition unit configured to acquire a first antenna strength that is a reception strength, at the mobile device, of a wireless signal transmitted from the first antenna;
a distance acquisition unit configured to acquire data indicating a distance from the mobile device to the wireless communication device by sequentially causing the plurality of antennas to communicate with the mobile device; and
a report processing unit configured to transmit data indicating the distance to the mobile device to a position determination device mounted on the vehicle in association with data indicating the first antenna strength.
